(19) United States
(12) Patent Application Publication
(10) Pub. No.: US 2025/0179982 A1
(43) Pub. Date: Jun. 5, 2025

(54) WATERCRAFT PROPULSION SYSTEM

(71) Applicant: YAMAHA HATSUDOKI KABUSHIKI KAISHA, Iwata-shi (JP)

(72) Inventor: Hiroshi INOUE, Shizuoka (JP)

(21) Appl. No.: 18/962,253

(22) Filed: Nov. 27, 2024

(30) Foreign Application Priority Data
Nov. 30, 2023 (JP) 2023-203275

(51) Int. Cl. F02N 11/08; B63H 20/00

(52) U.S. Cl. CPC F02N 11/0862; B63H 20/00; F02N 2200/062; F02N 2200/063

(57) ABSTRACT

A watercraft propulsion system includes an outboard motor and a battery to be mounted on a hull. The outboard motor includes a pair of connection terminals, a starter motor to be driven by electric power supplied from the pair of connection terminals, and an engine to be started by the starter motor. The watercraft propulsion system further includes a pair of battery cables to respectively connect a pair of terminals of the battery to the pair of connection terminals. Further, the watercraft propulsion system includes an estimation basic information acquirer to acquire, as estimation basic information to estimate the deterioration of the battery, a connection terminal voltage between the pair of connection terminals during driving of the starter motor.

### CROSS REFERENCE TO RELATED APPLICATIONS

This application claims the benefit of priority to Japanese Patent Application No. 2023-203275 filed on Nov. 30, 2023. The entire contents of this application are hereby incorporated herein by reference.

### BACKGROUND OF THE INVENTION

### 1. Field of the Invention

The present invention relates to watercraft propulsion systems. Further, the present invention relates to battery deterioration estimating units to be used in the watercraft propulsion systems. Furthermore, the present invention relates to watercraft each including the watercraft propulsion system.

### 2. Description of the Related Art

US 2009/0051364 A1 discloses an onboard battery management device for a motor vehicle. This device includes sensors that respectively measure the terminal voltage and the terminal electric current of an onboard battery, a computation processor that calculates and determines an internal resistance based on measurement values and determines the deterioration level of the battery, and a battery state display unit provided in a position viewable from a driver's seat to display the state of the battery.

### SUMMARY OF THE INVENTION

The inventor of example embodiments of the present invention described and claimed in the present application conducted an extensive study and research regarding watercraft propulsion systems, such as the one described above, and in doing so, discovered and first recognized new unique challenges and previously unrecognized possibilities for improvements as described in greater detail below.

In US 2009/0051364 A1, there is no description about the estimation of the deterioration of a battery to be mounted on a watercraft.

Particularly, in a watercraft including an outboard motor using an engine as a driving source, a battery that supplies electric power to a starter motor is mounted on a hull, and the battery and the outboard motor are connected to each other by a battery cable. Therefore, a distance between the battery and the outboard motor is long thus increasing the length of the battery cable. In addition, there are variations in the combination of the hull and the outboard motor so that the attachment position of the outboard motor with respect to the hull and the layout of the battery in the hull may vary. Therefore, the length of the battery cable depends on the design of each individual watercraft. Even if the art related to the onboard battery is used as it is, battery deterioration cannot accurately be estimated.

An example embodiment of the present invention provides a watercraft propulsion system to estimate the deterioration of a battery for an engine start of an outboard motor. Another example embodiment of the present invention provides a battery deterioration estimator to be used in the watercraft propulsion system. Another further example embodiment of the present invention provides a watercraft including the watercraft propulsion system described above.

An example embodiment of the present invention provides a watercraft propulsion system including an outboard motor and a battery to be mounted on a hull. The outboard motor includes a pair of connection terminals, a starter motor to be driven by electric power supplied from the pair of connection terminals, and an engine to be started by the starter motor. The watercraft propulsion system further includes a pair of battery cables to respectively connect a pair of terminals of the battery to the pair of connection terminals. Further, the watercraft propulsion system includes an estimation basic information acquirer configured or programmed to acquire, as estimation basic information to estimate the deterioration of the battery, a connection terminal voltage between the pair of connection terminals during driving of the starter motor.

When the starter motor is driven to start the engine, the electric power is supplied to the starter motor from the battery through the battery cables. At this time, a voltage drop occurs between the battery and the connection terminals of the outboard motor due to an electric current flowing through the battery cables. Unlike in the case of the motor vehicle, the battery cables that connect the battery mounted on the hull to the outboard motor each have a long length so that the voltage drop occurring in the battery cables influences the driving of the starter motor at the engine start. Therefore, the voltage drop occurring in the battery cables is not negligible. Unlike in the case of motor vehicles, individual watercraft are intrinsically different in the length of the battery cables and, therefore, suffer from different levels of the voltage drop occurring in the battery cables.

In the present example embodiment, therefore, the connection terminal voltage between the pair of connection terminals of the outboard motor is used to estimate the battery deterioration. More specifically, the connection terminal voltage observed during the driving of the starter motor is acquired as the estimation basic information to estimate the battery deterioration. The connection terminal voltage is a voltage between ends of the battery cables adjacent to the outboard motor when the electric current for the driving of the starter motor flows through the battery cables and, therefore, has a value determined in consideration of the voltage drop occurring in the battery cables. Therefore, the battery deterioration can be estimated in consideration of the voltage drop occurring in the battery cables, which are different in length depending on each individual watercraft. Specifically, battery deterioration permissible for the engine start can be estimated in consideration of the voltage drop occurring in the battery cables.

The connection terminal voltage may be detected, for example, by an engine controller (engine ECU (Electronic Control Unit)) provided on the outboard motor to control the engine of the outboard motor. The estimation basic information acquirer may be the engine controller. Alternatively, the estimation basic information acquirer may be some other element, unit, or device that acquires information about the connection terminal voltage from the engine controller through data communications.

In an example embodiment of the present invention, the estimation basic information acquirer is configured or programmed to acquire, as the estimation basic information, an electric current flowing through the battery cables during the driving of the starter motor. With this arrangement, the battery deterioration can be estimated by using the connection terminal voltage and the electric current flowing through the battery cables. For example, the battery deterioration may be estimated by evaluating the internal resistance of the battery with the use of the connection terminal voltage and the electric current.

In an example embodiment of the present invention, the estimation basic information acquirer is configured or programmed to acquire, as the estimation basic information, a battery terminal voltage between the pair of terminals of the battery during the driving of the starter motor. With this arrangement, the battery deterioration can be estimated by using the connection terminal voltage and the battery terminal voltage. For example, the battery deterioration may be estimated by measuring a drop in the connection terminal voltage and a drop in the battery terminal voltage when the starter motor is started, and evaluating a ratio between the connection terminal voltage drop and the battery terminal voltage drop.

In an example embodiment of the present invention, the watercraft propulsion system further includes a deterioration estimator configured or programmed to estimate the battery deterioration by using the estimation basic information acquired by the estimation basic information acquirer.

The deterioration estimator may be embodied, for example, by the function of the engine controller (engine ECU) provided on the outboard motor for the control of the engine of the outboard motor. Alternatively, the estimation basic information acquirer may be embodied by the function of some other device that acquires the information about the connection terminal voltage from the engine controller through data communications.

In an example embodiment of the present invention, the watercraft propulsion system further includes a communication terminal to communicate with a server to transmit the estimation basic information acquired by the estimation basic information acquirer to the server. The server is configured or programmed to function as the deterioration estimator by using the estimation basic information transmitted from the communication terminal.

The server is typically provided on the ground, i.e., outside the hull, but the server may be provided on the hull. Where the server is provided on the ground, the communication terminal typically communicates with the server via a network such as the internet to transmit the estimation basic information. The communication terminal may also function as the estimation basic information acquirer.

In this example embodiment, the battery deterioration is estimated in the server so that a client connectable to the server can acquire information about the battery deterioration from the server. This makes it easier to use the battery deterioration information. For example, the battery deterioration information can be used for the maintenance of the watercraft propulsion system.

In an example embodiment of the present invention, the watercraft propulsion system further includes a notifier to notify a user about the result of the estimate of the battery deterioration.

The notifier may include a display such as a gauge or an indicator provided on the watercraft. In this case, the notification about the result of the battery deterioration estimation is provided to the user by display. The server may function as the notifier. The server may display the result of the battery deterioration estimation on a webpage browsable by the client. Further, the server may provide the notification about the result of the battery deterioration estimation via an application installed in the client. Further, the server may transmit an email to a preliminarily registered mail address for the notification about the result of the battery deterioration estimation.

In an example embodiment of the present invention, the deterioration estimator is configured or programmed to estimate the battery deterioration by determining the internal resistance of the battery and evaluating the internal resistance (specifically, comparing the internal resistance with a threshold). In this case, the internal resistance is determined by using the connection terminal voltage included in the estimation basic information. Therefore, the internal resistance is determined in consideration of the length of the battery cables in each individual watercraft. By thus evaluating the internal resistance, the battery deterioration can be estimated in consideration of the length of the battery cables in each individual watercraft.

In an example embodiment of the present invention, the deterioration estimator is configured or programmed to estimate the battery deterioration by using a first voltage drop from an undriven-period connection terminal voltage between the pair of connection terminals before the driving of the starter motor to a minimum connection terminal voltage between the pair of connection terminals during the driving of the starter motor, and a second voltage drop from an undriven-period battery terminal voltage between the pair of terminals of the battery before the driving of the starter motor to a minimum battery terminal voltage between the pair of terminals of the battery during the driving of the starter motor (more specifically, by using a ratio between the first voltage drop and the second voltage drop).

Before the driving of the starter motor, no significant electric current flows through the battery cables so that the undriven-period connection terminal voltage is substantially equal to the undriven-period battery terminal voltage. Therefore, the undriven-period battery terminal voltage may be used as the undriven-period connection terminal voltage.

The connection terminal voltage is a voltage between the ends of the battery cables adjacent to the outboard motor, and the first voltage drop observed at the connection terminals includes a voltage drop component occurring in the battery cables as well as a voltage drop component due to the internal resistance of the battery. On the other hand, the second voltage drop observed at the battery terminals includes the voltage drop component due to the internal resistance of the battery but does not include the voltage drop component occurring in the battery cables. By using the first voltage drop and the second voltage drop, therefore, the battery deterioration can be estimated in consideration of the length of the battery cables intrinsic to each individual watercraft.

In an example embodiment of the present invention, the deterioration estimator is configured or programmed to estimate the battery deterioration by setting a threshold based on a minimum value of the ratio of the second voltage drop to the first voltage drop observed after the battery is incorporated in the watercraft propulsion system, and comparing the ratio of the second voltage drop to the first voltage drop with the threshold. The threshold may be set by multiplying the minimum value by a threshold factor.

In an example embodiment of the present invention, the deterioration estimator is configured or programmed to set the threshold based on the undriven-period battery terminal voltage and the minimum value. For example, the threshold may be set by multiplying the minimum value by a threshold factor that varies according to the undriven-period battery terminal voltage.

In an example embodiment of the present invention, the deterioration estimator is configured or programmed to estimate the battery deterioration by comparing, with a threshold, a voltage between the pair of connection terminals during a period in which the engine is cranked by the driving of the starter motor.

The threshold may be a minimum requirement voltage required to be applied to the starter motor during the cranking. By thus properly setting the threshold, whether or not the deterioration state of the battery is such that a voltage required for the cranking can be applied to the starter motor can be estimated irrespective of the length of the battery cables that varies depending on each individual watercraft.

The connection terminal voltage during the cranking of the engine is a voltage observed before the first ignition of the engine after being stabilized by a start of the rotation of the starter motor after a voltage drop peak period between an energization of the starter motor and the start of the starter motor. For example, the connection terminal voltage during the cranking of the engine may be a connection terminal voltage detected in a sampling cycle immediately before the first ignition of the engine. The first ignition of the engine can be detected, for example, when the rotation speed of the engine exceeds the rotation speed of the starter motor or when a load on the starter motor is alleviated so that the connection terminal voltage is returned to the undriven-period connection terminal voltage.

In an example embodiment of the present invention, the outboard motor includes a plurality of outboard motors connected together to the battery, and the engines of the respective outboard motors are sequentially started one by one. The deterioration estimator is configured or programmed to estimate the battery deterioration by using a smallest one of voltages between the pairs of connection terminals of the respective outboard motors when the starter motors of the respective outboard motors are driven.

With this arrangement, when the engines of the respective outboard motors are sequentially started, the connection terminal voltages of the outboard motors are monitored during the driving of the starter motors of the outboard motors. Then, the battery deterioration is estimated by using the smallest one of the connection terminal voltages. This makes it possible to check whether or not the battery deterioration state is such that all the engines of the outboard motors can be started.

Another example embodiment of the present invention provides the deterioration estimator for use in the watercraft propulsion system described above.

Another further example embodiment of the present invention provides a watercraft, which includes a hull, and a watercraft propulsion system mounted on the hull and having any of the aforementioned features.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram that outlines a watercraft information collecting system according to an example embodiment of the present invention.

FIG. 2 is a block diagram that describes a configuration of a watercraft by way of example.

FIG. 3 is a block diagram that describes a configuration of a server by way of example.

FIG. 4 is a block diagram showing a configuration of a communication terminal by way of example.

FIG. 5A is a block diagram that describes a configuration of a dealer client by way of example.

FIG. 5B is a block diagram that describes a configuration of a user client by way of example.

FIG. 6 is a flowchart that describes an exemplary operation to be performed by the communication terminal.

FIG. 7 is a diagram that describes a periodic transmission process to be performed by the communication terminal by way of example.

FIG. 8 is a flowchart that describes an exemplary process to be performed in the server.

FIG. 9 is a diagram to describe a first example of the estimation of battery deterioration.

FIGS. 10A and 10B are waveform diagrams respectively showing voltage waveforms and an electric current waveform observed at an engine start.

FIG. 11 is a flowchart that describes a battery deterioration estimation process according to the first example.

FIG. 12 is a diagram to describe a second example of the estimation of the battery deterioration.

FIG. 13 is a flowchart that describes a battery deterioration estimation process according to the second example.

FIG. 14 is a diagram to describe a third example of the estimation of the battery deterioration.

FIG. 15 is a flowchart that describes a battery deterioration estimation process according to the third example.

FIG. 16 is a flowchart showing an exemplary process to be performed by the communication terminal according to another example embodiment of the present invention.

### DETAILED DESCRIPTION OF THE EXAMPLE EMBODIMENTS

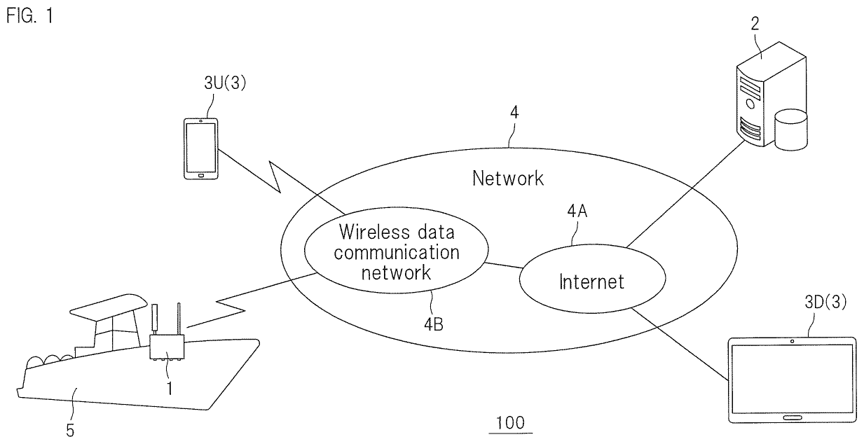

FIG. 1 is a diagram that outlines a watercraft information collecting system according to an example embodiment of the present invention. The watercraft information collecting system 100 includes a communication terminal 1 to collect and transmit information about devices on a watercraft 5, and a server 2 to communicate with the communication terminal 1. The communication terminal 1 may be provided on the watercraft 5. Further, the communication terminal 1 may be portable so that a crew member can bring the communication terminal 1 into the watercraft 5.

The communication terminal 1 and the server 2 are communicable with each other via a network 4. That is, the communication terminal 1 and the server 2 are each connected to the network 4 in a communicable manner. The network 4 typically includes an internet 4A. The communication terminal 1 is connected to a wireless data communication network 4B such as a mobile phone network in a communicable manner, and is connected to the internet 4A via the wireless data communication network 4B in a communicable manner.

The server 2 is typically communicable with a client 3. The client 3 may be a client terminal provided in a dealer office and/or a marina office (hereinafter referred to as “dealer client 3D”). Further, the client 3 may be a mobile terminal such as a smartphone to be carried by a user (hereinafter referred to as “user client 3U”). The dealer client 3D may be connectable to the internet 4A via a local area network (not shown) provided in the office, or may be connectable to the internet 4A via the wireless data communication network 4B. The user client 3U is typically connectable to the internet 4A via the wireless data communication network 4B. Further, the user client 3U may be connected to the communication terminal 1 in a data communicable manner in the watercraft. In this case, the user client 3U may be connectable to the network 4 via the communication terminal 1.

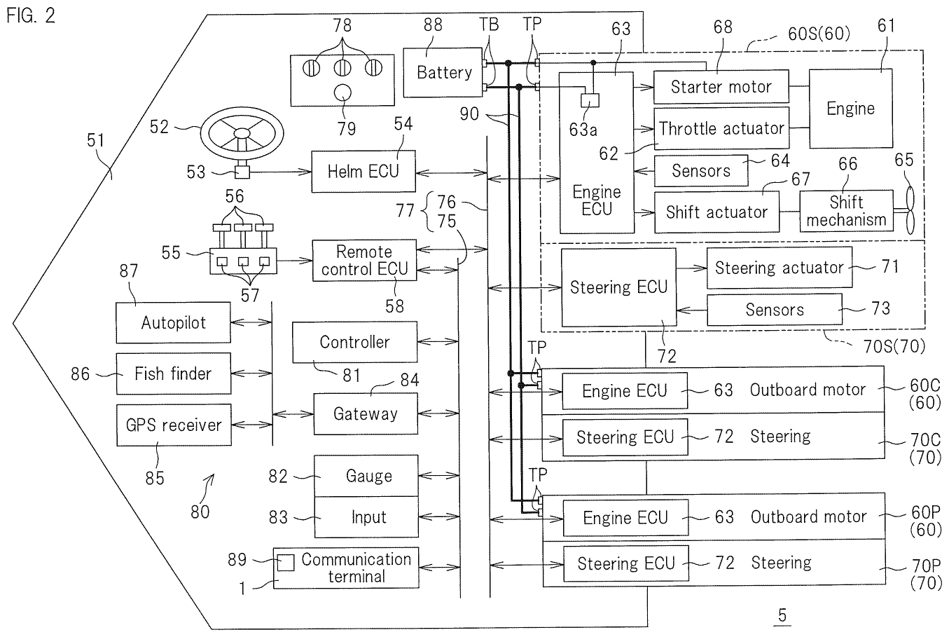

FIG. 2 is a block diagram that describes the configuration of the watercraft 5 by way of example. The watercraft 5 includes a hull 51, and various devices provided on the hull 51 (watercraft devices). The watercraft devices typically include an input device to maneuver the watercraft 5 (watercraft maneuvering device), a controller 81 to comprehensively control the devices provided in the watercraft 5, a propulsion device to apply a propulsive force to the hull 51, and a steering device (watercraft maneuvering device) to change the advancing direction of the hull 51. In this example embodiment, the communication terminal 1 is one of the watercraft devices.

In this example, the input device includes a steering wheel 52 and a remote controller 55.

In this example, the propulsion device includes an outboard motor 60 as an exemplary main device (main propulsion device). Specifically, the outboard motor 60 includes one or more outboard motors 60 on the stern of the hull 51. In this example, a plurality of outboard motors 60 (more specifically, three outboard motors 60) are disposed side by side and attached to the stern. In this example, the outboard motors 60 are engine outboard motors each including an engine 61 (internal combustion engine) as a power source to drive a propeller 65. Specifically, the three outboard motors 60 include a middle outboard motor 60C disposed at the middle, and a port-side outboard motor 60P and a starboard-side outboard motor 60S disposed on the left side and the right side, respectively, of the middle outboard motor 60C.

In this example, the steering device includes steerings 70 to respectively steer the outboard motors 60 leftward and rightward. The steerings 70 are provided in one-to-one correspondence with the outboard motors 60. In this example, three steerings 70 are provided. The three steerings 70 include a middle steering 70C, a port-side steering 70P and a starboard-side steering 70S, which correspond to the middle outboard motor 60C, the port-side outboard motor 60P and the starboard-side outboard motor 60S, respectively.

The steering wheel 52 is turned by a user (watercraft operator). The operation angle of the steering wheel 52 is detected by an operation angle sensor 53, and inputted to a helm ECU (Electronic Control Unit) 54. The remote controller 55 includes acceleration levers 56 to be operated by the user to adjust the directions (forward or reverse directions) and the magnitudes of propulsive forces to be generated by the respective outboard motors 60. The operation positions of the acceleration levers 56 are respectively detected by acceleration position sensors 57, and inputted to a remote control ECU 58.

The outboard motors 60 each include the engine 61, the propeller 65 that is driven by the engine 61, a shift mechanism 66, a starter motor 68 that starts the engine 61, and an engine ECU 63. The shift mechanism 66 has a plurality of shift positions, i.e., a forward shift position, a reverse shift position and a neutral shift position. With the shift position set to the forward shift position, the propeller 65 is rotated in the forward rotation direction by the driving force of the engine 61. With the shift position set to the reverse shift position, the propeller 65 is rotated in a reverse rotation direction by the driving force of the engine 61. With the shift position set to the neutral shift position, power transmission between the engine 61 and the propeller 65 is cut off. The engine ECU 63 controls the operation of a shift actuator 67 that actuates the shift mechanism 66 to control the direction of the propulsive force. Further, the engine ECU 63 controls the operation of a throttle actuator 62 that drives the throttle valve of the engine 61 to control the magnitude of the propulsive force.

The steerings 70 each include a steering actuator 71, and a steering ECU 72 to control the steering actuator 71. The steering actuator 71 generates power to pivot the corresponding outboard motor 60 leftward and rightward about its steering shaft (not shown). Thus, the direction of the propulsive force applied to the hull 51 by the outboard motor 60 is changed leftward and rightward such that the advancing direction of the watercraft 5 is changed. The steering 70 may be unitary with the corresponding outboard motor 60, or may be separate from the outboard motor 60. In FIG. 2, the steering 70 and the outboard motor 60 are configured as a unitary unit by way of example (e.g., the steering 70 is incorporated in the outboard motor 60).

A data communication network, i.e., an onboard network 77, is provided in the watercraft 5. In this example embodiment, the onboard network 77 includes a watercraft control CAN (Control Area Network) 75 and a propulsion device control CAN 76. The onboard network 77 may further include a multiplicity of daughter networks. An onboard system 80 includes the onboard network 77 and various watercraft devices connected to the onboard network 77. The onboard system 80 is an example of the watercraft propulsion system according to an example embodiment of the present invention.

The remote control ECU 58, the helm ECU 54, the engine ECUs 63 and the steering ECUs 72 are connected to the propulsion device control CAN 76. Therefore, an output command from the remote control ECU 58 is transmitted to the engine ECUs 63 via the propulsion device control CAN 76. The output command is a command signal indicating the directions (forward or reverse directions) and the magnitudes of the propulsive forces of the respective outboard motors 60. Further, a steering command outputted from the helm ECU 54 is transmitted to the steering ECUs 72 via the propulsion device control CAN 76. The steering command is a command signal corresponding to the operation direction (turning direction) and the operation angle of the steering wheel 52 and indicating the steering directions and the steering angles of the outboard motors 60.

The remote control ECU 58 is also connected to the watercraft control CAN 75. The controller 81 is further connected to the watercraft control CAN 75. Therefore, the controller 81 can acquire information about the output command from the remote control ECU 58.

Further, the controller 81 is able to acquire various information from the watercraft devices connected to the propulsion device control CAN 76, more specifically from the helm ECU 54, the engine ECUs 63 and the steering ECUs 72, via the remote control ECU 58.

Therefore, the controller 81 is able to acquire information about the steering command outputted from the helm ECU 54. Further, the controller 81 is able to acquire, for example, information about the steering command received by the steering ECUs 72, and information about the detection results of various sensors 73 provided in each of the steerings 70. The sensors 73 include, for example, a steering angle sensor. The steering angle sensor of the steering 70 detects the actual steering angle of the corresponding outboard motor 60. The steering angle sensor may detect the operation amount of the steering actuator 71. Further, the controller 81 can acquire various information from the engine ECUs 63. For example, the controller 81 can acquire information about the output command received by the engine ECUs 63, and information about the detection results of various sensors 64 provided in each of the outboard motors 60. The sensors 64 include, for example, a throttle opening degree sensor, an engine speed sensor and an engine temperature sensor. The throttle opening degree sensor detects the throttle valve opening degree of the engine 61 of the outboard motor 60. The engine speed sensor detects the rotation speed of the engine 61 (engine speed), and may be a crank angle sensor. The engine ECU 63 may be operable to process the output of the crank angle sensor to generate engine speed information. The engine temperature sensor may detect the cylinder block temperature (e.g., coolant temperature) of the engine 61, or may detect the exhaust temperature of the engine 61.

The communication terminal 1 and a gauge 82 to display various information are further connected to the watercraft control CAN 75. The communication terminal 1 is configured to transmit information about the state of the watercraft 5 and the like to the server 2 (see FIG. 1), more specifically, to transmit configuration information indicating the configuration of the watercraft 5 (particularly, the onboard system 80), failure information indicating a failure occurring in the onboard system 80, the detection values of the sensors, and the like to the server 2.

The gauge 82 functions as a display to display, for example, a residual fuel amount, the engine speeds and the shift positions of the respective outboard motors 60, a residual battery capacity, and the like. The residual battery capacity is the residual capacity of a battery 88 mounted on the hull 51 to actuate the starter motors 68 incorporated in the respective outboard motors 60 for engine start. The battery 88 discharges for the engine start, and is charged by power generators (not shown) incorporated in the respective outboard motors 60 during the operation of the engines 61. The gauge 82 may include an input device 83 such as input buttons and a touch panel. The input device 83 may be configured to be operated by the user to input various commands. The input device 83 may be provided separately from the gauge 82.

Other various watercraft devices may be connected to the watercraft control CAN 75 in a data communicable manner. Third party watercraft devices are typically connected to the watercraft control CAN 75 via a gateway 84. In FIG. 2, a GPS (Global Positioning System) receiver 85, a fish finder 86 and an autopilot device 87 are shown as examples of the third party watercraft devices. The GPS receiver 85 is an example of GNSS (Global Navigation Satellite System) positioning system, which detects the position of the watercraft 5.

The steering wheel 52 and the remote controller 55 are disposed in association with a helm seat, and main switches 78 to be operated to turn on and off power supply to the respective outboard motors 60 and to start and stop the engines 61 of the respective outboard motors 60 are also provided in association with the helm seat. Further, a kill switch 79 (emergency stop switch) to be operated to nullify the propulsive forces of the outboard motors 60 (typically to stop the engines 61) in an emergency is provided in association with the helm seat. The kill switch 79 has, for example, an operation end to which a lanyard cable carried by the user is connected. When the user falls overboard, the kill switch 79 is actuated for the emergency stop of the engines 61 of the outboard motors 60.

The communication terminal 1 is configured to be operative while receiving electric power from a communication terminal power supply 89. In this example embodiment, the communication terminal power supply 89 is incorporated in the communication terminal 1, but may be provided outside the communication terminal 1. An example of the communication terminal power supply 89 is a communication terminal battery or a communication terminal capacitor (typically, an electric double layer capacitor). In this case, the communication terminal power supply 89 preferably includes a charging circuit that charges the communication terminal battery or the communication terminal capacitor with the electric power from the battery 88 (main battery). The charging circuit may be configured to stop the charging of the communication terminal battery or the communication terminal capacitor if the voltage of the battery 88 is lower than a predetermined threshold. Another example of the communication terminal power supply 89 is a power supply maintaining circuit. The power supply maintaining circuit may be configured so as not to interrupt the connection between the battery 88 and the communication terminal 1 even if the onboard system 80 is out of use.

The battery 88 includes a pair of terminals TB. The outboard motors 60 each include a pair of connection terminals TP. The pair of terminals TB of the battery 88 are connected to the pair of connection terminals TP of each of the outboard motors 60 by a pair of battery cables 90. In this example embodiment, the three outboard motors 60 are connected together (in parallel) to the battery 88. The starter motors 68 of the respective outboard motors 60 are each driven by electric power supplied from the pair of connection terminals TP to crank the engine 61. For the startup of the two or more outboard motors 60, the engines 61 of the outboard motors 60 are started one by one in a predetermined sequence. In order to automatically sequentially start the engines 61 of the outboard motors 60 one by one, a controller (battery management unit) that sequentially connects the outboard motors 60 one by one to the battery 88 may be provided.

The engine ECUs 63 each include a voltmeter 63a that detects a voltage between the pair of connection terminals TP (connection terminal voltage), i.e., a voltage applied to the starter motor 68. The engine ECUs 63 are each able to provide information about the detected connection terminal voltage to any of the other watercraft devices (particularly to the communication terminal 1) via the onboard network 77.

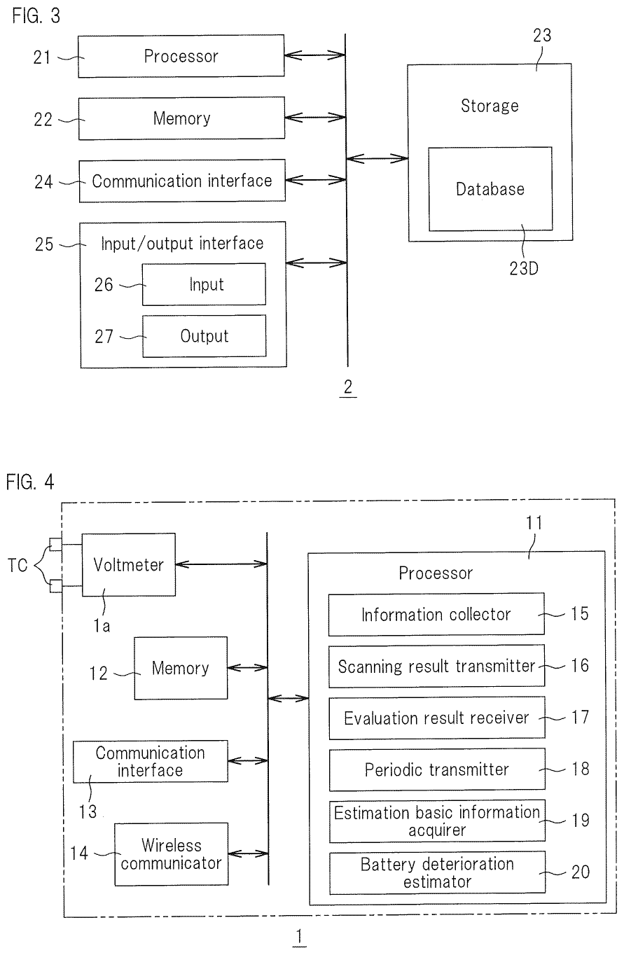

FIG. 3 is a block diagram that describes the configuration of the server 2 by way of example. The server 2 has a basic configuration as a computer. That is, the server 2 includes a processor 21, a memory 22, a storage 23, a communication interface 24 and an input/output interface 25, which are connected to each other in a data communicable manner.

The processor 21 is operative according to a program stored in the memory 22 to perform various functions. Specifically, the server 2 functions to communicate with the communication terminal 1 (see FIG. 1) to collect data from the communication terminal 1 and to accumulate the data in the storage 23. Further, the server 2 functions to evaluate the onboard system 80 based on the accumulated information to generate an evaluation result. The server 2 functions to communicate with the dealer client 3D (see FIG. 1) to provide a webpage to the dealer client 3D and to provide a web application service on the webpage. A web application program is stored in the memory 22 to provide the web application service. Further, the server 2 functions to communicate with the user client 3U (see FIG. 1) to provide information to an application provided in the user client 3U. The storage 23 provides a storage area for the accumulation of the data. The communication interface 24 interfaces with the network 4 for communications. The input/output interface 25 includes an input device 26 (e.g., a keyboard) and an output device 27 (e.g., a display) to serve as a man-machine interface.

A database 23D is provided in the storage 23 and, for a plurality of watercraft, configuration information indicating the configuration of the onboard system 80 of each individual watercraft is accumulated in the database 23D. The configuration information to be accumulated for the plural watercraft 5 includes configuration information transmitted from the communication terminal 1 of the each individual watercraft 5. The configuration information includes information about one or more of the watercraft devices of the onboard system 80. The configuration information about the watercraft devices may include information indicating the types (model names), the component numbers, the serial numbers, the software names, the software versions and the like of the watercraft devices. The configuration information may further include at least one (preferably all) of the number, the layout and the connection states of the watercraft devices. Particularly, the configuration information preferably includes information about the types (model names), the number, the layout and the connection states of the outboard motors 60 as the main devices and the steerings 70 respectively incorporated in the outboard motors 60.

For each of various watercraft devices to be possibly mounted on the watercraft 5, requirement information (operation conditions) required for the proper operation of the watercraft device in the onboard system 80 is registered in the database 23D. For example, the requirement information includes hardware requirements and/or software requirements that are essential or permissible for the mounting of the watercraft device. The hardware requirements are requirements (model names, component names and the like) of additional devices that are essential or permissible to be mounted together with the watercraft device in the onboard system 80. The software requirements are requirements (software names, software versions and the like) of software that is essential or permissible to be installed in the additional devices to be mounted together with the watercraft device in the onboard system 80.

Upon reception of the configuration information about the onboard system 80 from the communication terminal 1, the processor 21 evaluates the onboard system 80 by searching the database 23D for the corresponding requirement information, and generates an evaluation result. More specifically, the processor 21 determines whether or not the watercraft devices of the onboard system 80 are compatible with each other, and generates an evaluation result including a system compatibility determination result. If it is confirmed that all the watercraft devices properly operate without any problem with the compatibility among the watercraft devices, the system compatibility determination result is “acceptable.” If there is a possibility that at least one of the watercraft devices does not properly operate with some compatibility problem, the system compatibility determination result is “unacceptable.” The processor 21 transmits the system compatibility determination result to the communication terminal 1 via the communication interface 24. If the system compatibility determination result is unacceptable, the processor 21 may generate information about an unacceptable matter and/or information about a coping method for the elimination of the unacceptable matter, and transmit the information to the communication terminal 1.

Periodic transmission information to be periodically transmitted from the communication terminals 1 of the respective watercraft 5 is stored in the database 23D. That is, the processor 21 receives the periodic transmission information, and stores the periodic transmission information in the database 23D. The processor 21 performs processes with the use of the periodic transmission information. For example, the processor 21 may perform a troubleshooting process by using the periodic transmission information. The troubleshooting process typically includes an abnormality detection process to detect an abnormality, and preferably further includes an abnormality notification process to notify the user or the dealer about the detected abnormality. The notification process may include notification on the webpage provided to the dealer client 3D, and may include notification on the application of the user client 3U. Further, the notification process may include transmission of a mail to the registered mail address of the user and/or the dealer. The troubleshooting process may further include an information generation process to generate information about an abnormality cause identification process to identify the cause of the abnormality and information about an abnormality elimination process to eliminate the abnormality. The information generated by these processes may be covered by the notification process described above.

The troubleshooting process may include a battery deterioration estimation process to estimate the deterioration of the battery 88 of the onboard system 80. For example, the battery deterioration estimation process may be performed in the communication terminal 1, and the result of the battery deterioration estimation process may be included in the periodic transmission information. In this case, the server 2 stores the battery deterioration estimation result in the database 23D. In the troubleshooting process, whether or not the battery 88 is deteriorated is checked based on the battery deterioration estimation result and, if the battery 88 is deteriorated, the notification process may be performed to notify about the battery deterioration. Alternatively, the server 2 may acquire basic information required for the estimation of the deterioration of the battery 88 (estimation basic information) as the periodic transmission information from the communication terminal 1, and may perform the battery deterioration estimation process to estimate the deterioration of the battery 88.

FIG. 4 is a block diagram showing the configuration of the communication terminal 1 by way of example. The communication terminal 1 includes a processor 11, a memory 12, a communication interface 13 and a wireless communicator 14. The processor 11 is operative according to a program stored in the memory 12 to perform a plurality of functions. The communication interface 13 is configured for data communications via the onboard network 77. The wireless communicator 14 is configured for data communications with the server 2 via the network 4.

The processor 11 performs a data collecting function to collect information from the devices on the hull 51 via the onboard network 77 and store the collected information in the memory 12. The information to be collected include the configuration information about the devices (watercraft devices) on the hull 51. Further, the information to be collected may include the detection values of the various sensors. Specifically, the processor 11 can collect the detection values of the sensors 53, 57, 64, 73 connected to the helm ECU 54, the remote control ECU 58, the steering ECUs 72 and the engine ECUs 63. The information to be collected may further include information to be generated by the helm ECU 54, the remote control ECU 58, the steering ECUs 72 and the engine ECUs 63. The information may include control information (control commands and other data) to be generated in the ECUs, trouble information (error codes) to be detected by the ECUs, and the like. In this example embodiment, the processor 11 acquires information about the connection terminal voltages respectively detected by the voltmeters 63a from the engine ECUs 63 via the onboard network 77. The main switches 78, the kill switch 79, a start switch and other switches are regarded as sensors, and the states of these switches may be collected as the detection values. Further, the processor 11 may have a trouble detection function of monitoring the states of the various devices connected to the onboard network 77 and generating trouble information (failure information). For example, the processor 11 may monitor the states of the ECUs and detect the interruption of the operations of the ECUs occurring due to an instantaneous supply voltage drop as a trouble (instantaneous power failure). The collected information, the generated trouble information and the like are stored in the memory 12. The processor 11 is not necessarily required to collect information from all the devices connected to the onboard network 77. For example, the processor 11 is not required to cover the third party devices connected to the onboard network 77 via the gateway 84.

The processor 11 functions to transmit a portion or all of the information collected and/or generated by itself and stored in the memory 12 to the server 2 via the wireless communicator 14.

In this example embodiment, the processor 11 functions as an information collector 15 to collect information from the watercraft devices connected to the onboard network 77 via the communication interface 13. One function of the information collector 15 is to perform a system scanning process to collect the configuration information about the watercraft devices connected to the onboard network 77. The processor 11 functions as a scanning result transmitter 16 to perform a scanning result transmission process to cause the wireless communicator 14 to transmit the information collected by the system scanning process as a scanning result to the server 2. The server 2 receives the scanning result, and registers the scanning result as the configuration information about the onboard system 80 in the database 23D. Further, the server 2 evaluates the onboard system 80 based on the configuration information, and transmits the result of the evaluation to the communication terminal 1. The processor 11 also functions as an evaluation result receiver 17 to perform an evaluation result receiving process to cause the wireless communicator 14 to receive the evaluation result from the server 2. As described above, the evaluation result includes the system compatibility determination result and, if the system compatibility determination result is unacceptable, the evaluation result includes information about an unacceptable matter and/or a coping method against the unacceptable matter.

The processor 11 stores the information collected by the system scanning process as the scanning result in the memory 12. Further, the processor 11 stores the evaluation result (system compatibility determination result) received from the server 2 in the memory 12.

The processor 11 performs the system scanning process at the startup of the onboard system 80. Further, the processor 11 performs the system scanning process when an additional watercraft device is incorporated into the onboard network 77 to change the configuration of the onboard system 80.

The information collector 15 does not only collect the information by the system scanning process, but also collects various information from the watercraft devices via the onboard network 77 during the operation of the onboard system 80. The processor 11 functions as a periodic transmitter 18 to perform a periodic transmission process to transmit predetermined periodic transmission information to the server 2 at a predetermined periodic transmission interval during the operation of the onboard system 80. The periodic transmission interval may be, for example, about ten minutes. The periodic transmission information includes the information collected by the information collector 15 and includes, for example, operation information indicating the operation states of the outboard motors 60 (propulsion device). The periodic transmission information is uploaded to the server 2 to be accumulated in the database 23D, and is mainly used to later investigate into the presence/absence of any abnormality, a situation in which the abnormality occurs, and the like. In this example embodiment, the operation information includes operation period information to be described later.

The periodic transmission information includes an error code as required. Specifically, when an error code indicating the presence of an error appears on the onboard network 77 at the startup of the onboard system 80, the error code is incorporated in the periodic transmission information. If the error code is thereafter changed to another error code during the operation of the onboard system 80, the another error code is incorporated in the periodic transmission information. The transmission of the error code to the server 2 may be performed separately from the periodic transmission process.

Further, the processor 11 functions as an estimation basic information acquirer 19 configured or programmed to acquire the basic information (estimation basic information) required for the estimation of the deterioration of the battery 88 (see FIG. 2). The estimation basic information acquirer 19 may be configured or programmed to acquire the information about the connection terminal voltages respectively detected by the voltmeters 63a from the engine ECUs 63 via the onboard network 77. In this example embodiment, the communication terminal 1 also includes a voltmeter 1a. The voltmeter 1a measures a voltage between a pair of voltage measurement terminals TC of the communication terminal 1. The estimation basic information acquirer 19 may be configured or programmed to acquire the voltage measured by the voltmeter 1a as the estimation basic information.

Further, the processor 11 may function as a battery deterioration estimator 20 configured or programmed to determine, based on the estimation basic information collected by the estimation basic information acquirer 19, whether or not the battery 88 is deteriorated. The deterioration of the battery 88 may be estimated in the server 2 and, in this case, the processor 11 does not have the function as the battery deterioration estimator 20.

Where the deterioration of the battery 88 is estimated in the communication terminal 1, the result of the battery deterioration estimation process performed by the battery deterioration estimator 20 (typically, the determination result on whether or not the battery 88 is deteriorated) is preferably included in the periodic transmission information. Where the deterioration of the battery 88 is estimated in the server 2, the estimation basic information acquired by the estimation basic information acquirer 19 is preferably included in the periodic transmission information. The transmission of the result of the battery deterioration estimation process and/or the estimation basic information to the server 2 may be performed separately from the periodic transmission process.

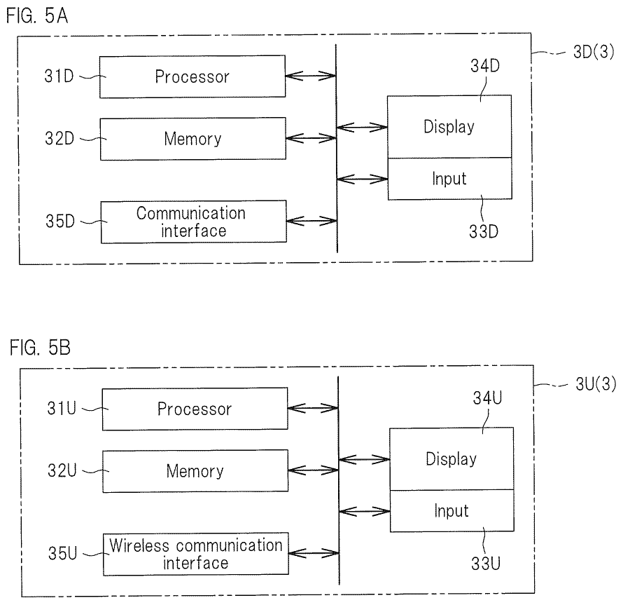

FIG. 5A is a block diagram that describes the configuration of the dealer client 3D by way of example. The dealer client 3D has a basic configuration as a computer. For example, the dealer client 3D may be a personal computer of desktop type, clamshell type or tablet type.

The dealer client 3D includes a processor 31D, a memory 32D, an input device 33D, a display 34D and a communication interface 35D. The processor 31D executes a program stored in the memory 32D to perform various functions. The input device 33D may be a touch panel on the display screen of the display 34D. The communication interface 35D interfaces with the network 4 for data communications. The communication interface 35D may communicate with the network 4 (see FIG. 1) via the local area network (not shown) provide in the dealer office, the marina office or the like through cable or wireless data communications. Further, the communication interface 35D may be configured to be connectable to the wireless data communication network 4B (see FIG. 1).

In the memory 32D, at least a web browser program is stored. The processor 31D executes the web browser program such that the user of the dealer client 3D (dealer staff, marina staff or the like) can browse the webpage provided by the server 2 to use the web application service provided on the webpage.

The user of the dealer client 3D can display the webpage on the display 34D. On the webpage thus displayed, the user of the dealer client 3D can receive information from the server 2. Specifically, the user of the dealer client 3D can acquire configuration information about a customer's watercraft 5, and can acquire information about a trouble (e.g., the deterioration of the battery 88) occurring in the customer's watercraft 5.

Further, an email receiving program (mailer) may be stored in the memory 32D. The processor 31D executes the email receiving program such that the user of the dealer client 3D can receive an email transmitted from the server 2. Thus, the notification about the trouble occurring in the customer's watercraft 5 and the like can be obtained from the server 2 by emails.

FIG. 5B is a block diagram that describes the configuration of the user client 3U by way of example. The user client 3U has a basic configuration as a computer. More specifically, the user client 3U has a basic configuration as a mobile terminal, still more specifically, has a basic configuration as a smartphone. The user client 3U includes a processor 31U, a memory 32U, an input device 33U, a display 34U and a wireless communication interface 35U.

The processor 31U executes a program stored in the memory 32U to perform various functions. The input device 33U may be a touch panel on the display screen of the display 34U. The wireless communication interface 35U interfaces with the network 4 (more specifically, the wireless data communication network 4B) for data communications. The wireless communication interface 35U may be configured to interface with the onboard network 77 for data communications. In this case, the user client 3U can be connected to the network 4 via the onboard network 77 and the communication terminal 1, allowing for data communications with the server 2.

An application program executable by the processor 31U (so-called native application program) is stored in the memory 32U. The processor 31U executes the native application program such that the user of the user client 3U (typically, the user or the owner of the watercraft 5) can acquire the information provided by the server 2 and display the information on the screen of the application program. Specifically, the application program makes it possible to acquire information about the state of the watercraft 5 (e.g., information about the position of the watercraft 5, the residual fuel amount and the trouble (e.g., the deterioration of the battery 88)), and the like.

Further, an email receiving program (mailer) may be stored in the memory 32U. The processor 31U executes the email receiving program such that the user of the user client 3U can receive an email transmitted from the server 2. Thus, the notification about the trouble occurring in the customer's watercraft 5 and the like can be obtained from the server 2 by emails.

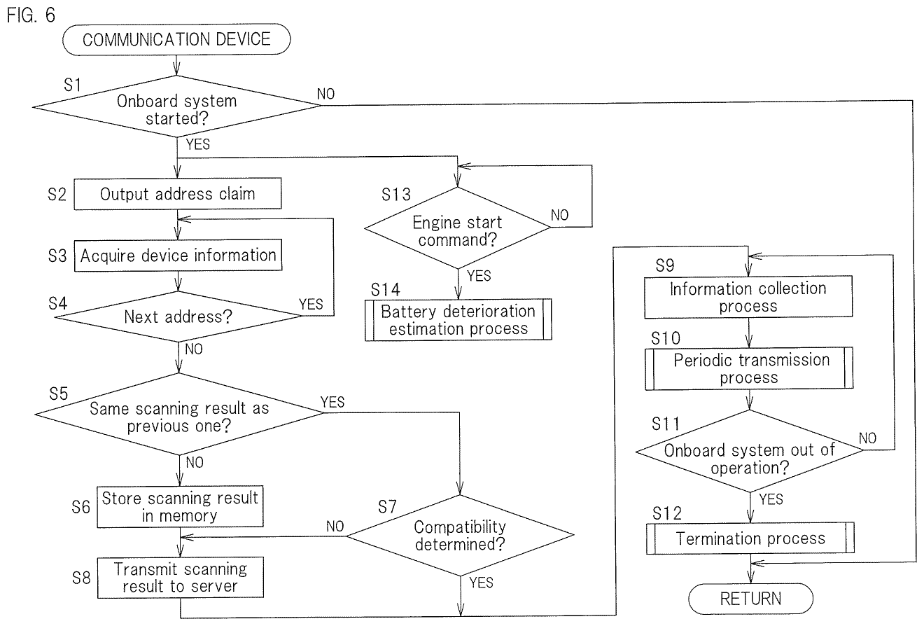

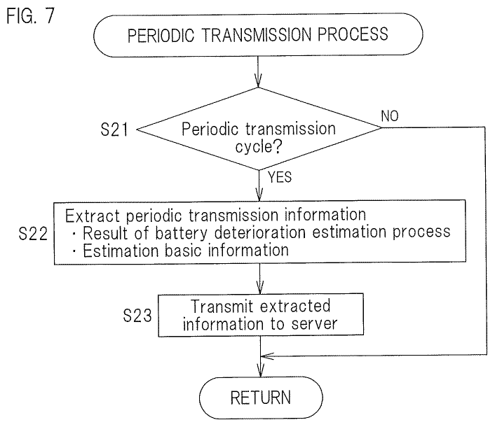

FIG. 6 is a flowchart that describes an exemplary operation to be performed by the communication terminal 1, mainly showing an exemplary process to be periodically performed by the processor 11 (see FIG. 4). The communication terminal 1 monitors the onboard system 80 for startup and, if the onboard system 80 is started (YES in Step S1), the communication terminal 1 performs a watercraft device information acquisition process to acquire information about the watercraft devices connected to the onboard network 77. When a message is outputted from any of the watercraft devices to the onboard network 77, for example, the communication terminal 1 may determine that the onboard system 80 is started. More specifically, when the message appears on the watercraft control CAN 75, the communication terminal 1 may determine that the onboard system 80 is started.

In order to acquire the information about the watercraft devices connected to the onboard network 77, the communication terminal 1 acquires the addresses of the watercraft devices connected to the watercraft control CAN 75 (Step S2). For the acquisition of the addresses, the communication terminal 1 may output an address claim to the onboard network 77 (specifically, to the watercraft control CAN 75) to claim its own address. The watercraft devices connected to the watercraft control CAN 75 are each configured to output an address claim to claim an address to be used in response to the address claim outputted to the watercraft control CAN 75 by the communication terminal 1. Thus, the communication terminal 1 can acquire the addresses of the respective watercraft devices connected to the watercraft control CAN 75 by outputting the address claim to the watercraft control CAN 75.

Next, the communication terminal 1 performs the system scanning process. Specifically, the communication terminal 1 transmits a configuration information transmission request to one of the watercraft devices connected to the onboard network 77 (more specifically, the watercraft control CAN 75) at any specific one of the acquired addresses. In response to the request, the watercraft device at the specific address transmits its configuration information to the communication terminal 1. The communication terminal 1 receives the configuration information, and stores the received configuration information in the memory 12. Thus, the configuration information about the watercraft device is acquired (Step S3, the function of the information collector 15). This process is performed repeatedly for all the watercraft devices at the acquired addresses (Step S4) such that the configuration information is acquired for all the watercraft devices connected to the onboard network 77.

The remote control ECU 58 collects information from the watercraft devices (the helm ECU 54, the engine ECUs 63 and the steering ECUs 72) connected to the propulsion device control CAN 76. That is, upon reception of the configuration information transmission request, the remote control ECU 58 does not only transmit its configuration information to the communication terminal 1, but also collects configuration information about the watercraft devices connected to the propulsion device control CAN 76 and transmits the collected configuration information to the communication terminal 1. Thus, the configuration information is collected for all the watercraft devices connected to the onboard network 77. The configuration information thus acquired by the system scanning process is the scanning result, and data indicating the scanning result is referred to as “scanning result data.” The configuration information about the communication terminal 1 itself is also included as the scanning result data.

The communication terminal 1 reads out previous scanning result data from the memory 12, and compares new (latest) scanning result data with the previous scanning result data to determine whether the new scanning result and the previous scanning result are consistent or inconsistent with each other (Step S5). If the previous scanning result data is not stored in the memory 12, the result of the determination is inconsistent. If the new scanning result is inconsistent with the previous scanning result (NO in Step S5), the communication terminal 1 stores the new scanning result data in the memory 12 (Step S6), and transmits the new scanning result data to the server 2 (Step S8, the function of the scanning result transmitter 16).

If the new scanning result is consistent with the previous scanning result (YES in Step S5), on the other hand, the communication terminal 1 checks if data indicating the system compatibility determination result (system compatibility determination result data) is stored in the memory 12. If the system compatibility determination result data is stored in the memory 12 and the system compatibility determination result data indicates an acceptable result (YES in Step S7), the communication terminal 1 does not transmit the scanning result data to the server 2. That is, where it has been determined that the compatibility among the watercraft devices of the onboard system 80 is acceptable, the onboard system 80 has a proper configuration and, therefore, the communication terminal 1 does not transmit the scanning result data to the server 2. In this case, the communication terminal 1 does not need to store the new scanning result data in the memory 12. Of course, the new scanning result data may be stored in the memory 12. If the new scanning result is consistent with the previous scanning result (YES in Step S5) but the determination of the compatibility among the watercraft devices is not completed yet (NO in Step S7), the communication terminal 1 transmits the latest scanning result to the server 2 (Step S8).

On the other hand, the communication terminal 1 collects the information outputted from the watercraft devices to the onboard network 77 during the operation of the onboard system 80, and stores the collected information in the memory 12 (Step S9, an information collection process as the function of the information collector 15). Then, the communication terminal 1 performs the periodic transmission process to periodically transmit predetermined periodic transmission information out of the collected information (Step S10, the function of the periodic transmitter 18).

The communication terminal 1 monitors whether or not the use of the onboard system 80 is continued, i.e., whether or not the onboard system 80 is in operation (Step S11). If the onboard system 80 is in operation, the information collection process (Step S9) and the periodic transmission process (Step S10) are continued. If the termination of the use of the onboard system 80 is detected (YES in Step S11), the communication terminal 1 performs a termination process (Step S12). In the termination process, the communication terminal 1 may be shifted to a sleep mode (energy saving mode).

Whether or not the onboard system 80 is in operation (in use) can be detected (Step S11), for example, by monitoring information periodically appearing on the onboard network 77. For example, when the power supply to the onboard system 80 is on, the engine ECUs 63 are in operation to periodically output engine speed data to the onboard network 77. Therefore, if no engine speed data appears on the onboard network 77 for longer than a predetermined period of time, the communication terminal 1 may determine that the use of the onboard system 80 is terminated.

If the onboard system 80 is started (YES in Step S1), on the other hand, the communication terminal 1 monitors whether or not an engine start command is applied (Step S13). If the engine start command is applied, the communication terminal 1 performs a battery deterioration estimation process (Step S14, the function of the battery deterioration estimator 20).

Though not shown, the communication terminal 1, when receiving the system compatibility determination result data from the server 2, stores the data in the memory 12 (the function of the evaluation result receiver 17). Further, the communication terminal 1 transmits the system compatibility determination result data to the gauge 82. Thus, the gauge 82 displays the system compatibility determination result on its screen. Immediately after the onboard system 80 is constructed and immediately after the onboard system 80 is modified, for example, the gauge 82 displays information such that the system scanning process is not performed yet. The gauge 82 may display a message “PERFORM SYSTEM SCANNING PROCESS” in a popup manner. The display mainly aims at information transmission to a service person of a boat builder or a dealer. The gauge 82 continuously displays this information until the system compatibility determination result data indicating acceptable compatibility is written.

If the communication terminal 1 writes the system compatibility determination result data received from the server 2 on the gauge 82 and the system compatibility determination result data indicates the acceptable compatibility, the gauge 82 deletes the displayed information (e.g., the popup information). If the system compatibility determination result data indicates unacceptable compatibility, the gauge 82 displays information indicating the unacceptable compatibility. Where the system compatibility determination result data includes information indicating the cause of an unacceptable matter and/or a coping method against the unacceptable matter, the gauge 82 may also display such information.

The boat builder or the dealer has a service-dedicated tool for the troubleshooting of the onboard system 80. The service-dedicated tool is typically a personal computer, and executes a dedicated application to function as a troubleshooting device. The service-dedicated tool is connected to the onboard network 77 such that the system scanning process described above can be performed with the use of the service-dedicated tool. Further, the service-dedicated tool has a communication function to communicate with the server 2. Therefore, like the communication terminal 1, the use of the service-dedicated tool makes it possible to perform the system scanning process, to transmit the scanning result to the server 2, and to receive the system compatibility determination result. In addition to these functions, the service-dedicated tool may have the function of, for example, downloading the latest software for a watercraft device from the server and installing the latest software in the watercraft device.

FIG. 7 is a flowchart that describes an example of the periodic transmission process (Step S10 in FIG. 6) to be performed by the communication terminal 1 when the onboard system 80 is in operation. In every periodic transmission cycle (occurring, for example, at a periodic transmission interval of 10 minutes) (YES in Step S21), the communication terminal 1 transmits the periodic transmission information to the server 2. More specifically, predefined information classified as the periodic transmission information is extracted from the information stored in the memory 12 by the information collection process (Step S9 in FIG. 6) (Step S22), and the extracted information is transmitted as the periodic transmission information to the server 2 (Step S23).

The periodic transmission information includes information about the operation of the outboard motors 60, more specifically, engine operation information. For example, the engine operation information includes information about engine operation periods for a plurality of predefined engine speed ranges, information about total engine operation periods from the start of the engines, and the like. The engine operation information may further include an over-revolution count, an overheat count, a lower oil pressure count, a knocking control count, a reverse rotation count, and the like. The periodic transmission information may further include information about the detection values of the various sensors. The communication terminal 1 periodically collects the engine operation information and the detection values of the sensors from the watercraft devices via the onboard network 77 (Step S9 in FIG. 6). A periodic collection interval for the periodic collection is shorter than the periodic transmission interval.

Where the battery deterioration estimation process (Step S14 in FIG. 6) is performed in the communication terminal 1, the result of the battery deterioration estimation process is included in the periodic transmission information. The basic information for the estimation of the battery deterioration (estimation basic information) may also be included in the periodic transmission information. In another example embodiment, the battery deterioration estimation process is not performed in the communication terminal 1 but in the server 2. In this case, the estimation basic information needs to be transmitted to the server 2.

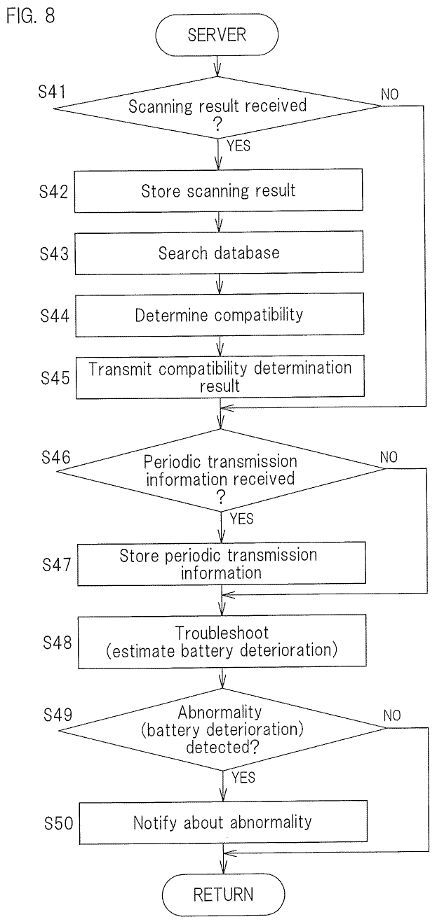

FIG. 8 is a flowchart that describes an exemplary process to be performed in the server 2, mainly showing a process to be periodically performed by the processor 21 (see FIG. 3). The server 2 receives the scanning result data from the communication terminal 1 of the watercraft 5 (Step S41), and accumulates the received scanning result data in the storage 23 (Step S42).

For each of the watercraft devices, the requirement information that describes the requirements for the proper operation of the watercraft device is stored in the database 23D provided in the storage 23. The requirement information typically includes essential requirement information that describes essential requirements for the proper operation of the watercraft device. The requirements include, for example, information about the other watercraft devices to be provided together with the watercraft device in the same onboard system and information about software for the other watercraft devices.

The server 2 searches the database 23D based on the scanning result data (Step S43). Then, the server 2 determines whether the compatibility among the watercraft devices of the onboard system 80 is acceptable or unacceptable by determining whether or not the watercraft devices each satisfy the requirement information (Step S44). The result of the compatibility determination is transmitted as the system compatibility determination result data to the communication terminal 1 (Step S45).

If the result of the compatibility determination is unacceptable, the server 2 preferably identifies unacceptable requirement information, and transmits the unacceptable requirement information as unacceptable matter information to the communication terminal 1. The unacceptable matter information may include information about a coping method for the elimination of an unacceptable matter instead of the information about the unacceptable matter or in addition to the information about the unacceptable matter. As described above, the unacceptable matter and/or the coping method against the unacceptable matter may be displayed on the gauge 82 of the onboard system 80. For example, a message “ENGINE ECU CONTAINS OLD ROM INFORMATION. REWRITE ECU.” may be displayed on the gauge 82.

Further, where new software is available on any of the watercraft devices of the onboard system 80, the server 2 may notify the communication terminal 1 about the availability of the new software. In this case, the server 2 preferably preliminarily confirms that the compatibility determination result is acceptable even if the new software is incorporated. The communication terminal 1, when being notified about the availability of the new software, preferably displays the availability of the new software on the gauge 82. This can prompt the user or the service person to use the new software.

The new software can be incorporated (installed) in the watercraft device by connecting the service-dedicated tool to the onboard network 77. The communication terminal 1 may have the function of downloading the new software from the server 2. Then, the incorporation (installation) of the software in the watercraft device may be achieved, for example, by using the gauge 82 and the input device 83 as a man-machine interface.

Further, the server 2 receives the periodic transmission information from the communication terminal 1 (Step S46), and registers the received periodic transmission information in the database 23D (Step S47). For example, the server 2 performs the troubleshooting process based on the information registered in the database 23D (Step S48). If any abnormality is detected by the troubleshooting process (YES in Step S49), the server 2 may perform the abnormality notification process to notify about the abnormality (Step S50). The abnormality notification process may include one or more of the displaying on the webpage provided by the server 2, the notification by the application provided in the user client 3U, and the transmission of a mail to the dealer or the user (or the owner).

In the communication terminal 1, the battery deterioration estimation process (Step S14 in FIG. 6) is performed. If the result of the battery deterioration estimation process is included in the periodic transmission information, it is determined, in the troubleshooting process (Step S48), whether or not the result of the battery deterioration estimation process indicates the deterioration of the battery 88. If the deterioration of the battery 88 occurs (YES in Step S49), abnormality information indicating the occurrence of the battery deterioration is provided (Step S50).

In another example embodiment, the battery deterioration estimation process is performed in the server 2, and the periodic transmission information includes the estimation basic information. In this case, the troubleshooting process (Step S48) includes the battery deterioration estimation process (the function of the battery deterioration estimator). If the result of the battery deterioration estimation process indicates that the deterioration of the battery 88 occurs (YES in Step S49), abnormality information indicating the occurrence of the battery deterioration is provided (Step S50).

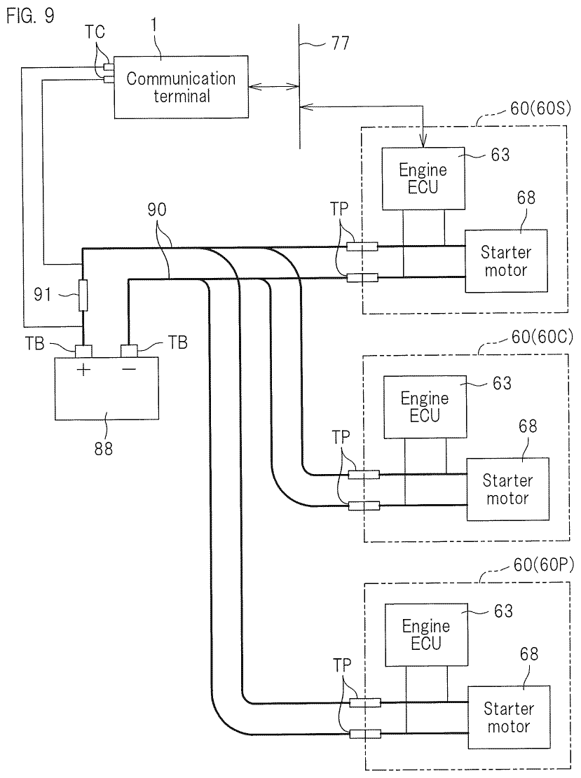

FIG. 9 is a diagram to describe a first example of the estimation of the deterioration of the battery 88. The outboard motors 60 are each connected to the battery 88 by the pair of battery cables 90. More specifically, the pair of terminals TB of the battery 88 are connected to the pair of connection terminals TP of each of the outboard motors 60 by the pair of battery cables 90. The starter motors 68 provided in the respective outboard motors 60 are each driven by the electric power supplied from the corresponding pair of connection terminals TP. In this example, a connection terminal voltage V between each pair of connection terminals TP during the driving of the starter motor 68 (here, a peak voltage (minimum voltage)) is measured. Further, an electric current I flowing through the battery cables 90 during the driving of the starter motor 68 (here, a peak electric current (maximum electric current)) is detected. Then, the internal resistance R=V/I of the battery 88 is computed by using the connection terminal voltage V and the electric current I. The value of the internal resistance R contains the resistance component of the battery cables 90. Therefore, the use of the internal resistance R makes it possible to estimate the deterioration of the battery 88 in consideration of the resistance component (e.g., the length) of the battery cables 90.

The connection terminal voltage V during the driving of the starter motor 68 can be detected by the engine ECU 63 (more specifically, the voltmeter 63a (see FIG. 2)). The data of the detected connection terminal voltage V is transmitted to the onboard network 77, and the communication terminal 1 can acquire the data (the function of the estimation basic information acquirer 19). The electric current I flowing through the battery cables 90 during the driving of the starter motor 68 can be measured by detecting a voltage between the opposite terminals of a shunt resistor 91 provided in the middle of one of the battery cables 90. For example, the pair of voltage measurement terminals TC of the communication terminal 1 are connected to the opposite terminals of the shunt resistor 91 such that the communication terminal 1 (more specifically, the voltmeter 1a (see FIG. 4)) can acquire the data of the electric current A. Alternatively, an electric current sensor using a current transformer may be provided in one of the battery cables 90, and the output signal of the electric current sensor may be inputted to the communication terminal 1.

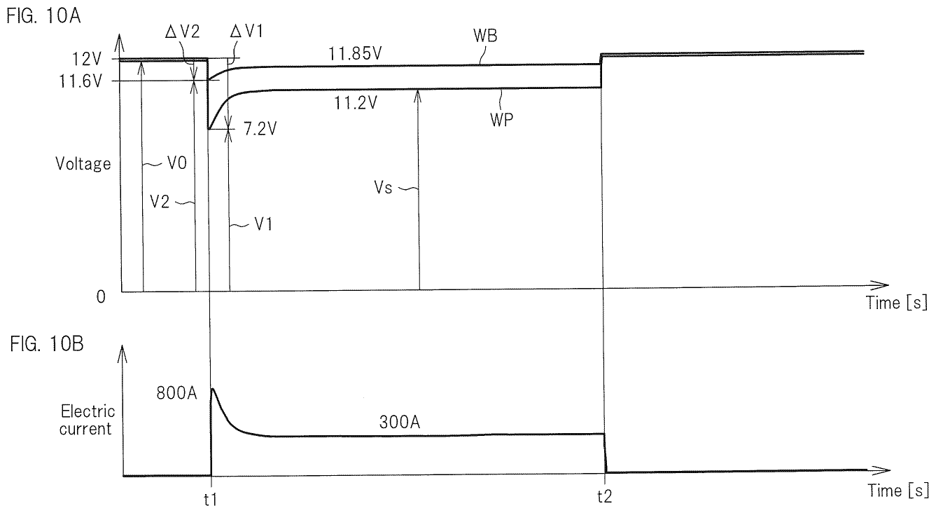

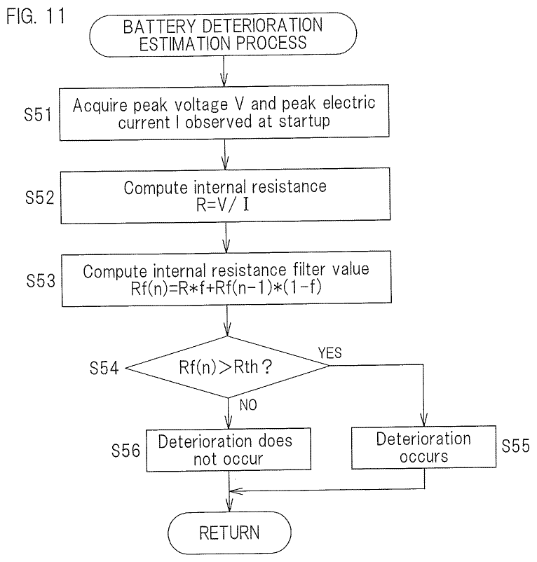

FIGS. 10A and 10B are waveform diagrams respectively showing voltage waveforms and an electric current waveform observed at the engine start. A voltage waveform WB shows the waveform of the voltage between the terminals TB of the battery 88 (battery terminal voltage). A voltage waveform WP shows the waveform of the voltage between the connection terminals TP of the outboard motor 60 (connection terminal voltage).

During an undriven period (non-energized period) in which the starter motor 68 is not driven, no electric current flows through the battery cables 90, so that no voltage drop occurs in the battery cables 90. Therefore, there is substantially no difference between the battery terminal voltage (voltage waveform WB) and the connection terminal voltage (voltage waveform WP) (which are each an undriven-period voltage V0 of about 12V, for example). After the driving of the starter motor 68 is started at a time t1 by the application of the engine start command, a significant electric current flows through the battery cables 90 during the energization of the starter motor 68. Thus, the battery terminal voltage (voltage waveform WB) and the connection terminal voltage (voltage waveform WP) correspondingly drop.

A drop in the battery terminal voltage (voltage waveform WB) is attributable to the internal resistance (e.g., about 0.5 mΩ) of the battery 88. A drop in the connection terminal voltage (voltage waveform WP) is attributable not only to the internal resistance of the battery 88 but also to the electrical resistances of the battery cables 90 and the contact resistances of the terminals (four terminals each having a contact resistance of 0.5 mΩ, for example). The battery cables 90 each have an electrical resistance that mainly depends on the length thereof, and a change in the resistance value thereof due to the temperature and the deterioration is negligible. The electrical resistance of the battery cable 90 per unit length (1 m) is, for example, 0.654 mΩ/m. Where the battery cables 90 each have a length of 5.32 m, for example, an electrical resistance contributable to the drop in the connection terminal voltage (voltage waveform WP) is about 6 mΩ. Therefore, the drop in the connection terminal voltage (voltage waveform WP) is greater than the drop in the battery terminal voltage (voltage waveform WB).

Immediately after the energization, the starter motor 68 and the engine 61 are stationary and, therefore, suffer from correspondingly greater loads, so that a greater electric current flows therethrough. Thereafter, the starter motor 68 starts rotating, and the engine 61 starts cranking. Then, the loads are reduced to be stabilized so that the electric current is reduced. Therefore, the electric current waveform is such that the electric current rises to a peak value (800 A in FIG. 10B) immediately after the startup, and then decreases to be stabilized, for example, at about 300 A during the cranking. Correspondingly, the battery terminal voltage (voltage waveform WB) drops to a peak value (a minimum voltage V2 of 11.6 V in FIG. 10A) immediately after the startup, and then increases to be stabilized, for example, at about 11.85 V during the cranking. Similarly, the connection terminal voltage (voltage waveform WP) drops to a peak value (a minimum voltage V1 of 7.2 V in FIG. 10A) immediately after the startup, and then increases to be stabilized at a stabilization voltage Vs (e.g., about 11.2 V) during the cranking.

When the first ignition occurs at a time t2, the rotation speed of the engine 61 exceeds the rotation speed of the starter motor 68. Then, the starter motor 68 suffers from no load, so that the electric current is substantially zero. The battery terminal voltage (voltage waveform WB) and the connection terminal voltage (voltage waveform WP) are returned to the undriven-period voltage V0 (e.g., about 12 V).

FIG. 11 is a flowchart that describes an example of the battery deterioration estimation process (Step S14 in FIG. 6) to be performed by using the internal resistance R. In this example, upon the detection of the engine start command (Step S13 in FIG. 6), the processor 11 of the communication terminal 1 performs the process shown in FIG. 11 (the functions of the estimation basic information acquirer 19 and the battery deterioration estimator 20).

When the starter motor 68 is driven to start the engine 61, the communication terminal 1 acquires the peak value of the connection terminal voltage V (the peak voltage V which is the minimum voltage V1 in FIG. 10A) and the peak value of the electric current I flowing through the battery cables 90 (the peak electric current I which is the maximum electric current) observed at this time (Step S51, the function of the estimation basic information acquirer 19). For the startup of the engines 61 of the plural outboard motors 60, the outboard motors 60 are sequentially connected one by one to the battery 88 so as to sequentially start the engines 61 one by one. In this case, the peak voltage V and the peak electric current I are measured for each of the outboard motors 60. Then, the smallest one of the peak voltages V measured for the respective outboard motors 60 and the corresponding one of the peak electric currents I are used as the estimation basic information.

The communication terminal 1 computes the internal resistance R=V/I by using the peak voltage V and the peak electric current I (Step S52, the function of the battery deterioration estimator 20). Further, the communication terminal 1 performs a filtering process (here, a low-pass filtering process) represented by the following expression (differential equation) to determine an internal resistance filter value Rf(n) corresponding to the internal resistance (Step S53, the function of the battery deterioration estimator 20). That is, a new internal resistance filter value Rf(n) is determined by using the new internal resistance R and the previous internal resistance filter value Rf(n−1),

$$Rf ( n ) = R * f + ( n - 1 ) ⋆ ( 1 - f )$$

wherein n is a natural number that is incremented by one every time the engine is started and indicates an engine start number, and f is a filter coefficient which is, for example, f=0.001. The initial value Rf(0) of the internal resistance filter value Rf(n) is, for example, Rf(0)=Rth/2, wherein Rth is a determination threshold to be used when the deterioration of the battery 88 is determined based on the internal resistance filter value Rf(n).

The internal resistance filter value Rf(n) thus determined is compared with the determination threshold Rth (Step S54). If Rf(n)>Rth, it is determined that the deterioration of the battery 88 occurs (the battery 88 has a deterioration level such that battery replacement is recommended) (Step S55). Otherwise, it is determined that the deterioration of the battery 88 does not occur (the battery 88 does not reach the deterioration level such that the battery replacement is recommended) (Step S56, the function of the battery deterioration estimator 20).

In this exemplary process, the internal resistance is determined by using the voltage between the connection terminals TP of the battery cables 90 adjacent to the outboard motor 60 so that the length of the battery cables 90 in each individual watercraft 5 can be taken into consideration for the determination of the internal resistance. The battery deterioration can be estimated in consideration of the length of the battery cables 90 in each individual watercraft 5 by evaluating the internal resistance.

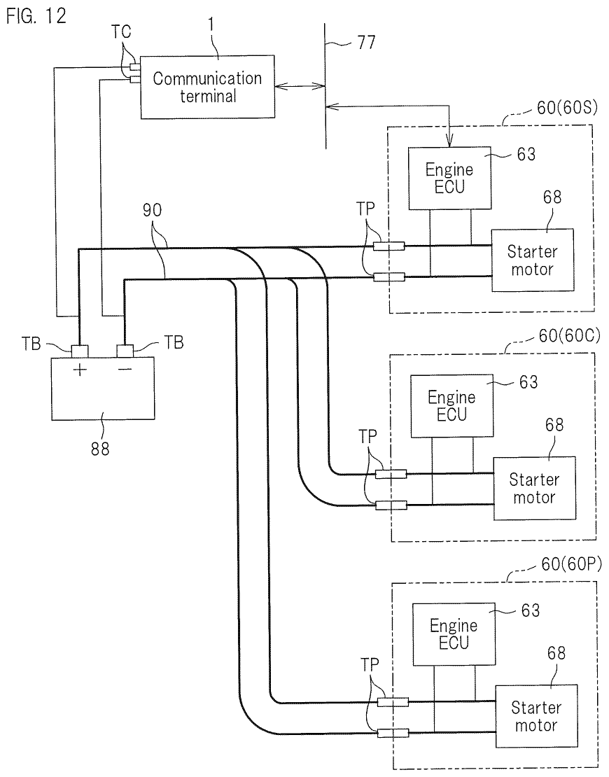

FIG. 12 is a diagram to describe a second example of the estimation of the deterioration of the battery 88. In FIG. 12, components corresponding to those shown in FIG. 9 will be denoted by the same reference characters as in FIG. 9. In the second example, the minimum value of the connection terminal voltage between the pair of connection terminals TP during the driving of the starter motor 68 (the peak voltage, which is the minimum voltage V1 in FIG. 10A) is measured as in the first example. In the second example, the undriven-period battery terminal voltage V0 (see FIG. 10A) between the pair of terminals TB of the battery 88 before the driving of the starter motor 68 (i.e., during the starter motor undriven period) is measured. Further, the minimum value of the battery terminal voltage between the pair of terminals TB of the battery 88 during the driving of the starter motor 68 (the peak voltage, which is the minimum voltage V2 in FIG. 10A) is measured.

Then, a first voltage drop ΔV1 (see FIG. 10A) which is a voltage drop observed at the connection terminals TP between the starter motor undriven period and the starter motor driven period (a voltage drop observed at the start of the driving of the starter motor 68) is determined. Further, a second voltage drop ΔV2 (see FIG. 10A) which is a voltage drop in the battery terminal voltage observed between the starter motor undriven period and the starter motor driven period (a voltage drop observed at the start of the driving of the starter motor 68) is determined. Since the electric current flowing through the battery cables 90 during the starter motor undriven period is negligible, it may be considered that the connection terminal voltage observed during the starter motor undriven period is equal to the undriven-period battery terminal voltage V0. Therefore, the first voltage drop ΔV1 and the second voltage drop ΔV2 can be respectively calculated from the following two expressions:

$$Δ V 1 = V 0 - V 1$$

$$Δ V 2 = V 0 - V 2$$

The minimum connection terminal voltage V1 can be detected by the engine ECU 63. The data of the detected minimum connection terminal voltage V1 is transmitted to the onboard network 77, and acquired by the communication terminal 1 (the function of the estimation basic information acquirer 19). The undriven-period battery terminal voltage V0 observed during the starter motor undriven period and the minimum battery terminal voltage V2 observed at the start of the driving of the starter motor 68 can be measured, for example, by the voltmeter 1a of the communication terminal 1 (see FIG. 4), and the data of the voltages V0, V2 can be acquired by the communication terminal 1.

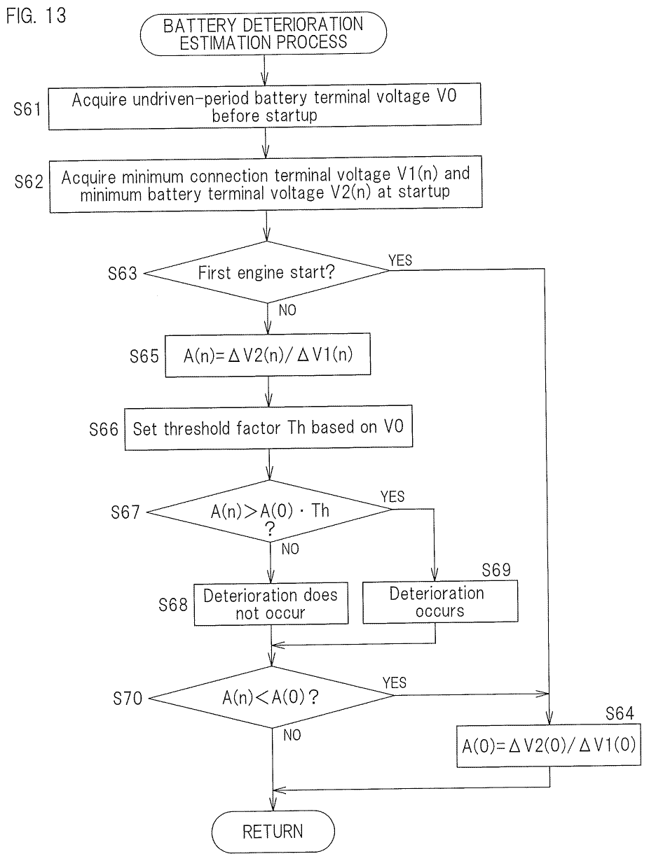

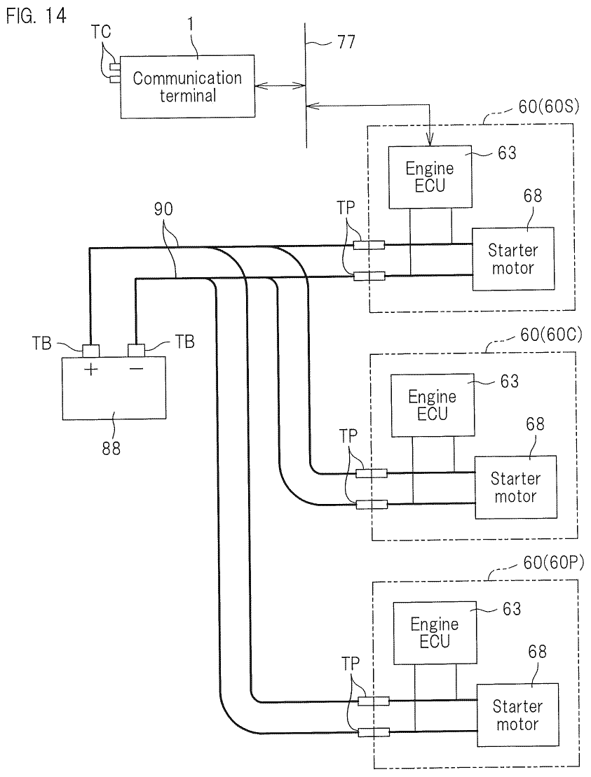

FIG. 13 is a flowchart that describes an example of the battery deterioration estimation process (Step S14 in FIG. 6) to be performed by using the voltage drops ΔV1, ΔV2. In this example, upon the detection of the engine start command (Step S13 in FIG. 6), the processor 11 of the communication terminal 1 performs the process shown in FIG. 13 (the functions of the estimation basic information acquirer 19 and the battery deterioration estimator 20).

The undriven-period battery terminal voltage V0 observed before the driving of the starter motor 68 for the startup of the engine 61 is acquired (Step S61, the function of the estimation basic information acquirer 19). Further, the minimum connection terminal voltage V1(n) (the peak value of the connection terminal voltage) and the minimum battery terminal voltage V2(n) (the peak value of the battery terminal voltage) are acquired when the starter motor 68 is driven to start the engine 61 (Step S62, the function of the estimation basic information acquirer 19), wherein n is an integer that is incremented by one every time the engine is started after a new battery 88 is incorporated, and indicates the engine start number (the initial value of n is zero).

For the startup of the engines 61 of the plural outboard motors 60, the outboard motors 60 are sequentially connected one by one to the battery 88 so as to sequentially start the engines 61 one by one. In this case, the minimum connection terminal voltage V1 and the minimum battery terminal voltage V2 are measured for each of the outboard motors 60. Then, the smallest one of the minimum connection terminal voltages V1 measured for the respective outboard motors 60 and the corresponding one of the minimum battery terminal voltages V2 are used as the estimation basic information.

The communication terminal 1 determines whether or not the engine 61 is started for the first time after the new battery 88 is incorporated (Step S63). For example, immediately after the new battery is incorporated (e.g., immediately after the battery 88 is replaced with the new battery), information about the incorporation of the new battery may be inputted from the input device 83 of the gauge 82 or the like, and the inputted information may be shared with the communication terminal 1, so that the communication terminal 1 can detect the first engine start. If the first engine start is detected (YES in Step S63), the communication terminal 1 stores the ratio ΔV2(n)/ΔV1(n) of the second voltage drop ΔV2(n) (=ΔV2(0)) to the first voltage drop ΔV1(n) (=ΔV1(0)) as a minimum value A(0) (=ΔV2(n)/ΔV1(n)=ΔV2(0)/ΔV1(0)) in the memory 12, and ends the process (Step S64).

If the second or subsequent engine start is detected (NO in Step S63), the communication terminal 1 computes the ratio A(n)=ΔV2(n)/ΔV1(n) of the second voltage drop ΔV2(n) to the first voltage drop ΔV1(n) (Step S65). Further, the communication terminal 1 determines a threshold factor Th based on the undriven-period battery terminal voltage V0 (Step S66). The threshold factor Th may be set so as to be increased as the undriven-period battery terminal voltage V0 decreases. Examples of the threshold factor Th are shown in the following table:

| V0 (V) | Th |
|---|---|
| 14 | 1.30 |
| 13 | 1.35 |
| 12 | 1.40 |
| 11 | 1.45 |

The communication terminal 1 computes a threshold A(0). Th by multiplying the minimum value A(0) by the threshold factor Th, and compares the voltage drop ratio A(n) with the threshold A(0)·Th (Step S67). If A(n)≤A(0)·Th (i.e., A(n)/A(0)≤Th) (NO in Step S67), it is determined that the deterioration of the battery 88 does not occur yet (Step S68). If A(n)>A(0)·Th (i.e., A(n)/A(0)>Th) (YES in Step S67), on the other hand, it is determined that the deterioration of the battery 88 occurs (Step S69).

If the battery 88 is increasingly deteriorated to have a higher internal resistance, the battery terminal voltage drop ΔV2 increases. On the other hand, the voltage drop occurring in the battery cables 90 does not depend on the internal resistance of the battery 88. Therefore, the increase in the voltage drop ratio A(n) means that the internal resistance of the battery 88 increases. Thus, the deterioration of the battery 88 can be determined by comparing the ratio A(n) with the threshold A(0)·Th. On the other hand, the voltage drop depends on the electric current so that the deterioration of the battery 88 can be more advantageously determined by using the threshold factor Th that varies according to the undriven-period battery terminal voltage V0.

The ratio A(n) has a value corresponding to the internal resistance of the battery 88 so that the ratio A(n) is reduced as the internal resistance decreases. However, the ratio A(n) does not necessarily have the smallest value at the first engine start. Therefore, the minimum value A(0) is compared with the ratio A(n) (Step S70) and, if A(n)<A(0), the minimum value A(0) is updated by substituting the latest ratio A(n) for the minimum value A(0) (Step S64).

FIG. 14 is a diagram that describes a third example of the estimation of the deterioration of the battery 88. In FIG. 14, components corresponding to those shown in FIG. 9 will be denoted by the same reference characters as in FIG. 9. In the third example, the connection terminal voltage between the pair of connection terminals TP during the driving of the starter motor 68 is measured as in the first example. In the third example, however, the peak voltage (minimum voltage) observed immediately after the start of the driving of the starter motor 68 is not measured, but a voltage observed during a stabilization period (during the cranking) after the starter motor 68 starts rotating (the stabilization voltage Vs, see FIG. 10A) is measured. More specifically, a connection terminal voltage observed immediately before the first ignition of the engine 61 may be used as the stabilization voltage Vs. The connection terminal voltage during the cranking can be detected by the engine ECU 63. The data of the detected connection terminal voltage is transmitted to the onboard network 77, and acquired by the communication terminal 1 (the function of the estimation basic information acquirer 19).

The first ignition of the engine 61 can be determined, for example, by monitoring that the rotation speed of the engine 61 exceeds the rotation speed of the starter motor 68. Further, if the load on the starter motor 68 is eliminated by the first ignition, the connection terminal voltage (voltage waveform WP) and the battery terminal voltage (voltage waveform WB) are returned to the undriven-period voltage (e.g., in 5 ms to 10 ms after the first ignition) as shown in FIG. 10A. Therefore, the first ignition of the engine 61 may be detected based on the return of the voltages.

For example, the engine ECU 63 repeatedly measures the connection terminal voltage at a predetermined voltage measurement interval (e.g., at a sampling interval of 10 ms). In this case, a connection terminal voltage measured in a voltage measurement cycle immediately before the detection of the first ignition of the engine 61 or in the second voltage measurement cycle preceding the detection of the first ignition may be used for the estimation of the deterioration of the battery 88. Of course, a connection terminal voltage measured in the third or earlier voltage measurement cycle preceding the detection of the first ignition may be used, as long as the connection terminal voltage (stabilization voltage Vs) is measured in the stabilization period during the cranking. If the voltage measurement interval is 10 ms and the engine ECU 63 requires 10 ms for the detection of the first ignition, for example, it is reasonable to use a connection terminal voltage measured in a voltage measurement cycle occurring 20 ms before the engine ECU 63 detects the first ignition.

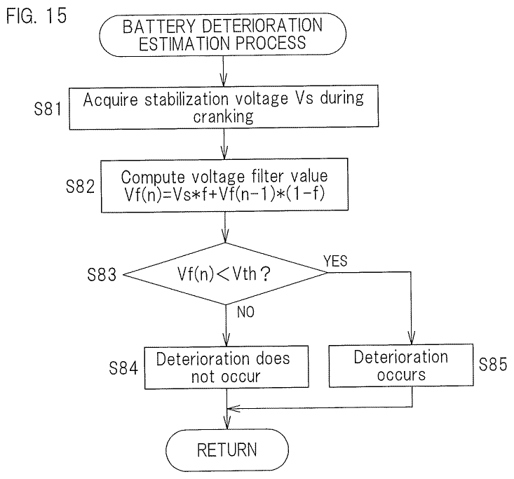

FIG. 15 is a flowchart that describes an example of the battery deterioration estimation process (Step S14 in FIG. 6) according to the third example. In this example, if the engine start command is detected (Step S13 in FIG. 6), the processor 11 of the communication terminal 1 performs the process shown in FIG. 15 (the functions of the estimation basic information acquirer 19 and the battery deterioration estimator 20).

When the starter motor 68 is driven to start the engine 61, the connection terminal voltage (stabilization voltage Vs) measured during the cranking is acquired in the communication terminal 1 (Step S81, the function of the estimation basic information acquirer 19). For the startup of the engines 61 of the plural outboard motors 60, the outboard motors 60 are sequentially connected one by one to the battery 88 so as to sequentially start the engines 61 one by one. In this case, the connection terminal voltage (stabilization voltage Vs) during the cranking is measured for each of the outboard motors 60. Then, the smallest one of the stabilization voltages Vs measured for the respective outboard motors 60 is used as the estimation basic information.

Subsequently, the communication terminal 1 performs a filtering process (here, a low-pass filtering process) represented by the following expression (differential equation) by using the connection terminal voltage (stabilization voltage Vs) acquired as the estimation basic information. Thus, the communication terminal 1 computes a voltage filter value Vf(n) corresponding to the connection terminal voltage (stabilization voltage Vs) (Step S82, the function of the battery deterioration estimator 20). That is, a new voltage filter value Vf(n) is computed by using the new connection terminal voltage (stabilization voltage Vs) and the previous voltage filter value Vf(n−1),

$$Vf ( n ) = Vs ⋆ f + Vf ( n - 1 ) * ( 1 - f )$$

wherein n is a natural number that is incremented by one every time the engine is started and indicates an engine start number, and f is a filter coefficient which is, for example, f=0.001. The initial value Vf(0) of the voltage filter value Vf(n) is, for example, Vf(0)=Vth+1, wherein Vth is a determination threshold to be used when the deterioration of the battery 88 is determined based on the voltage filter value Vf(n).

The voltage filter value Vf(n) thus determined is compared with the determination threshold Vth (Step S83, the function of the battery deterioration estimator 20). If Vf(n)≥Vth (NO in Step S83), it is determined that the deterioration of the battery 88 does not occur yet (Step S84). If Vf(n)<Vth (YES in Step S83), the deterioration of the battery 88 occurs (the battery 88 has a deterioration level such that battery replacement is recommended) (Step S85).

The determination threshold Vth is preferably predefined based on a minimum requirement voltage required to be applied to the starter motor 68 during the cranking. Thus, the deterioration of the battery 88 can be detected when the voltage filter value Vf(n) is less than the minimum requirement voltage. Since the deterioration of the battery 88 is determined based on the connection terminal voltage measured on the side of the outboard motor 60, the determination result can be provided in consideration of the influence of the length of the battery cables 90.

In this example embodiment, as described above, the onboard system 80 is configured with the plurality of watercraft devices connected to the onboard network 77. The onboard system 80 is an example of the watercraft propulsion system according to an example embodiment of the present invention, and includes the outboard motors 60, the battery 88 mounted on the hull 51, and the pair of battery cables 90 that connect the outboard motors 60 to the battery 88. The outboard motors 60 each include the pair of connection terminals TP, the starter motor 68 to be driven by the electric power supplied from the pair of connection terminals TP, and the engine 61 to be started by the starter motor 68. The pair of battery cables 90 respectively connect the pair of terminals TB of the battery 88 to the pair of connection terminals TP. The connection terminal voltage between the pair of connection terminals TP during the driving of the starter motor 68 is used as the estimation basic information for the estimation of the deterioration of the battery 88.

When the starter motor 68 is driven to start the engine 61, the electric power is supplied to the starter motor 68 from the battery 88 through the battery cables 90. At this time, the voltage drop occurs between the battery 88 and the connection terminals TP of the outboard motor 60 due to the electric current flowing through the battery cables 90. Unlike in the case of the motor vehicle, the battery cables 90 for the connection between the outboard motors 60 and the battery 88 mounted on the hull 51 each have a greater length and, therefore, the voltage drop occurring in the battery cables 90 influences the driving of the starter motor 68 at the engine start. Accordingly, the voltage drop occurring in the battery cables 90 is not negligible. Unlike in the case of the motor vehicle, the length of the battery cables 90 is intrinsically different depending on the watercraft 5 so that the voltage drop occurring in the battery cables 90 is different depending on the watercraft 5.

In this example embodiment, therefore, the connection terminal voltage between the pair of connection terminals TP of the outboard motor 60 is used for the estimation of the battery deterioration. More specifically, the connection terminal voltage observed during the driving of the starter motor 68 is acquired as the estimation basic information for the estimation of the battery deterioration. The connection terminal voltage is a voltage between the ends of the battery cables 90 adjacent to the outboard motor 60 when the electric current flows through the battery cables 90 for the driving of the starter motor 68 and, therefore, has a value determined in consideration of the voltage drop occurring in the battery cables 90. Therefore, the battery deterioration can be estimated in consideration of the voltage drop occurring in the battery cables 90 that are different in length depending on the watercraft 5. That is, the deterioration of the battery 88 that is permissible for the engine start can be estimated in consideration of the voltage drop occurring in the battery cables 90.

In this example embodiment, the plural outboard motors 60 (three outboard motors 60) are connected together to the battery 88. For the startup of the engines 61 of two or more outboard motors 60, the engines 61 are sequentially started one by one. That is, the two or more outboard motors 60 to be started are sequentially connected one by one to the battery 88. In this case, the connection terminal voltage is monitored for each of the outboard motors 60 during the driving of the starter motors 68 of the outboard motors 60. Then, the deterioration of the battery 88 is estimated by using the smallest one of the connection terminal voltages monitored for the respective outboard motors 60. This makes it possible to check if the deterioration state of the battery 88 is such that all the engines 61 of the respective outboard motors 60 can be started.

Further, the estimation result of the deterioration of the battery 88 is registered in the server 2 so that the dealer staff, the user and the like can acquire the information about the deterioration of the battery 88 from the server 2 with the use of the client 3. This makes it easier to use the information about the deterioration of the battery 88, for example, as reference information for maintenance.

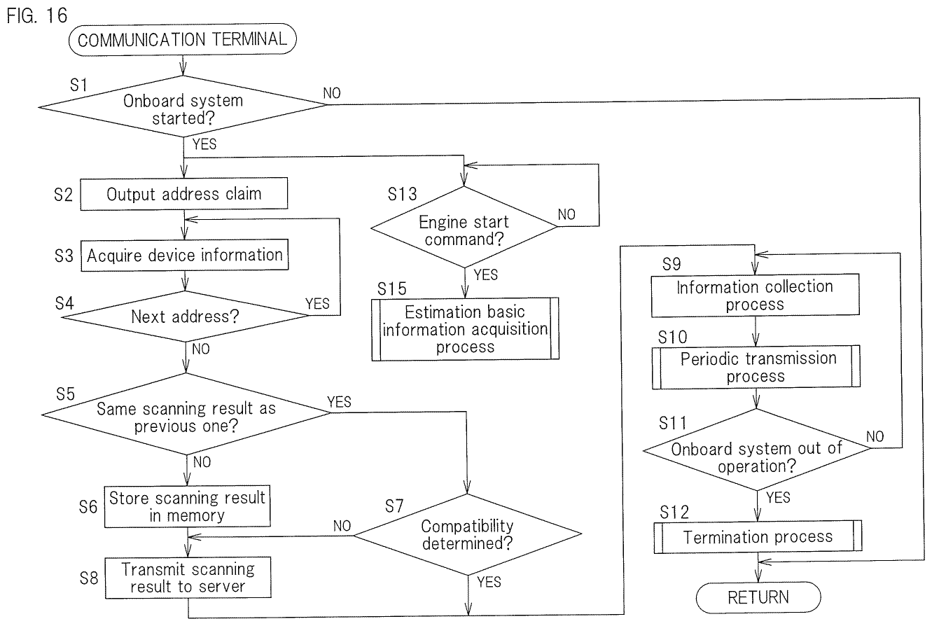

FIG. 16 is a flowchart showing an exemplary process to be performed by the communication terminal 1 according to another example embodiment of the present invention. In FIG. 16, process steps to be performed in the same manner as in FIG. 6 will be denoted by the same reference characters as in FIG. 6. Reference will also be made to FIGS. 1 to 15.

In this example embodiment, the estimation basic information is transmitted from the communication terminal 1 to the server 2, and the battery deterioration estimation process is performed in the server 2. Therefore, the communication terminal 1 performs an estimation basic information acquisition process (Step S15) to acquire the estimation basic information if detecting the engine start command (YES in Step S13). The acquired estimation basic information is incorporated in the periodic transmission information, and transmitted to the server 2 (Step S10).

The battery deterioration estimation process to be performed in the server 2 may be included in the troubleshooting process (Step S48 in FIG. 8, the function of the battery deterioration estimator). If it is determined by the battery deterioration estimation process that the deterioration of the battery 88 occurs (YES in Step S49), the server 2 performs the abnormality notification process to notify about the battery deterioration (Step S50).

The battery deterioration estimation process to be performed in the server 2 may be performed in the same manner as that to be performed by the battery deterioration estimator 20 of the communication terminal 1 according to an example embodiment previously described.

In the battery deterioration estimation process according to the first example shown in FIG. 11, for example, the peak voltage V (minimum voltage V1) of the connection terminal voltage and the peak electric current I (maximum electric current) observed immediately after the start of the driving of the starter motor 68 for the engine start are transmitted as the estimation basic information to the server 2 by the communication terminal 1. Based on the estimation basic information, the server 2 performs a process sequence from Step S52 to Step S56 in FIG. 11.

In the battery deterioration estimation process according to the second example shown in FIG. 13, the undriven-period battery terminal voltage V0 observed before the driving of the starter motor 68 is transmitted as the estimation basic information to the server 2 by the communication terminal 1. Further, the minimum connection terminal voltage V1 observed immediately after the start of the driving of the starter motor 68 and the minimum battery terminal voltage V2 observed immediately after the start of the driving of the starter motor 68 are transmitted as the estimation basic information to the server 2 by the communication terminal 1. Based on the estimation basic information, the server 2 performs a process sequence from Step S62 to Step S70 in FIG. 13.

In the battery deterioration estimation process according to the third example shown in FIG. 15, the terminal voltage (stabilization voltage Vs) observed during the stabilization period in which the starter motor 68 is driven to crank the engine 61 is transmitted as the estimation basic information to the server 2 by the communication terminal 1. Based on the estimation basic information, the server 2 performs a process sequence from Step S82 to Step S85 in FIG. 15.

Also in this example embodiment, the estimation result of the deterioration of the battery 88 is registered in the server 2, so that the dealer staff, the user and the like can acquire the information about the deterioration of the battery 88 from the server 2 with the use of the client 3. This makes it easier to use the information about the deterioration of the battery 88, for example, as the reference information for the maintenance.

While several example embodiments of the present invention have thus been described, the present invention may be embodied in some other ways as will be described below by way of example.

In the example embodiments described above, the battery deterioration estimation process is performed in the communication terminal 1 or in the server 2 by way of example. Alternatively, the battery deterioration estimation process may be performed in substantially the same manner, for example, in the engine ECU 63. Further, the battery deterioration estimation process may be performed by any of the other ECUs and controllers provided in the onboard system 80.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft propulsion system comprising:
an outboard motor including a pair of connection terminals, a starter motor to be driven by electric power supplied from the pair of connection terminals, and an engine to be started by the starter motor;
a battery to be mounted on a hull;
a pair of battery cables to respectively connect a pair of terminals of the battery to the pair of connection terminals; and
an estimation basic information acquirer configured or programmed to acquire, as estimation basic information to estimate deterioration of the battery, a connection terminal voltage between the pair of connection terminals during driving of the starter motor.

2. The watercraft propulsion system according to claim 1, wherein the estimation basic information acquirer is configured or programmed to acquire, as the estimation basic information, an electric current flowing through the battery cables during the driving of the starter motor.

3. The watercraft propulsion system according to claim 1, wherein the estimation basic information acquirer is configured or programmed to acquire, as the estimation basic information, a battery terminal voltage between the pair of terminals of the battery during the driving of the starter motor.

4. The watercraft propulsion system according to claim 1, further comprising a deterioration estimator configured or programmed to estimate the battery deterioration by using the estimation basic information acquired by the estimation basic information acquirer.

5. The watercraft propulsion system according to claim 4, further comprising:
a communication terminal to communicate with a server to transmit the estimation basic information acquired by the estimation basic information acquirer to the server; wherein
the server is configured or programmed to function as the deterioration estimator by using the estimation basic information transmitted from the communication terminal.

6. The watercraft propulsion system according to claim 4, further comprising a notifier to notify a user about a result of the estimate of the battery deterioration.

7. The watercraft propulsion system according to claim 4, wherein the deterioration estimator is configured or programmed to estimate the battery deterioration by determining an internal resistance of the battery and evaluating the internal resistance.

8. The watercraft propulsion system according to claim 4, wherein the deterioration estimator is configured or programmed to estimate the battery deterioration by using:
a first voltage drop from an undriven-period connection terminal voltage between the pair of connection terminals before the driving of the starter motor to a minimum connection terminal voltage between the pair of connection terminals during the driving of the starter motor; and
a second voltage drop from an undriven-period battery terminal voltage between the pair of terminals of the battery before the driving of the starter motor to a minimum battery terminal voltage between the pair of terminals of the battery during the driving of the starter motor.

9. The watercraft propulsion system according to claim 8, wherein the deterioration estimator is configured or programmed to estimate the battery deterioration by setting a threshold based on a minimum value of a ratio of the second voltage drop to the first voltage drop observed after the battery is incorporated in the watercraft propulsion system, and comparing the ratio of the second voltage drop to the first voltage drop with the threshold.

10. The watercraft propulsion system according to claim 9, wherein the deterioration estimator is configured or programmed to set the threshold based on the undriven-period battery terminal voltage and the minimum value.

11. The watercraft propulsion system according to claim 4, wherein the deterioration estimator is configured or programmed to estimate the battery deterioration by comparing, with a threshold, a voltage between the pair of connection terminals during a period in which the engine is cranked by the driving of the starter motor.

12. The watercraft propulsion system according to claim 4, wherein
the outboard motor includes a plurality of outboard motors connected together to the battery;
the engines of the respective outboard motors are sequentially started one by one; and
the deterioration estimator is configured or programmed to estimate the battery deterioration by using a smallest one of voltages between the pairs of connection terminals of the respective outboard motors when the starter motors of the respective outboard motors are driven.

13. The deterioration estimator for use in the watercraft propulsion system according to claim 4.

14. A watercraft comprising:
a hull; and
the watercraft propulsion system according to claim 1 mounted on the hull.
